(19) United States
(12) Patent Application Publication
(10) Pub. No.: US 2023/0140168 A1
(43) Pub. Date: May 4, 2023

(54) SYSTEM AND METHOD FOR COMPENSATING FOR ATTENUATION OF SEISMIC ENERGY

(71) Applicant: Chevron U.S.A. Inc., San Ramon, CA (US)

(72) Inventors: Yonghe J. Sun, Cypress, TX (US); Chunling Wu, Houston, TX (US); Mark Chengliang Fan, Sugar Land, TX (US)

(21) Appl. No.: 17/515,043

(22) Filed: Oct. 29, 2021

(51) Int. Cl. G01V 1/34; G01V 1/30

(52) U.S. Cl. CPC G01V 1/345; G01V 1/305; G01V 2210/6222; G01V 2210/67

(57) ABSTRACT

A method is described for seismic data processing including receiving a seismic dataset D(s, r; t) representative of a subsurface volume of interest; calculating a pre-migration attenuated travel time t*(s, r; t); performing a first migration on D(s, r; t) to generate common image point (CIP) gathers G(x, h); performing a second migration on D(s, r; t)*t*(s, r; t) to generate weighted common image point (CIP) gathers G_{t*}(x, h); and calculating a conditioned ratio of the weighted CIP gathers G_{t*}(x, h) over the CIP gathers G(x, h) to get CIP gathers of attenuated traveltime t*(x, h). The CIP gathers of attenuated traveltime t*(x, h) may be used to perform seismic tomography to generate an attenuation (Q) model.

### CROSS-REFERENCE TO RELATED APPLICATIONS

Not applicable.

### STATEMENT REGARDING FEDERALLY SPONSORED RESEARCH OR DEVELOPMENT

Not applicable.

### TECHNICAL FIELD

The disclosed embodiments relate generally to techniques for compensating for attenuation of seismic energy used in exploration for subsurface reservoirs and, in particular, to a method of calculating attenuation to be used in tomography for obtaining the frequency-independent quality factor Q for seismic imaging and inversion.

### BACKGROUND

Seismic exploration involves surveying subterranean geological media for hydrocarbon deposits. A survey typically involves deploying seismic sources and seismic sensors at predetermined locations. The sources generate seismic waves, which propagate into the geological medium creating pressure changes and vibrations. Variations in physical properties of the geological medium give rise to changes in certain properties of the seismic waves, such as their direction of propagation and other properties.

Portions of the seismic waves reach the seismic sensors. Some seismic sensors are sensitive to pressure changes (e.g., hydrophones), others to particle motion (e.g., geophones), and industrial surveys may deploy one type of sensor or both. In response to the detected seismic waves, the sensors generate corresponding electrical signals, known as traces, and record them in storage media as seismic data. Seismic data will include a plurality of “shots” (individual instances of the seismic source being activated), each of which are associated with a plurality of traces recorded at the plurality of sensors.

One of the primary indicators of hydrocarbon accumulation is seismic amplitudes. Seismic wave propagations suffer energy attenuation because the Earth is not totally elastic. Frequency-independent quality factor (Q) has been found adequate to model seismic wave attenuation. Seismic imaging of the subsurface using reflection seismic data requires modeling the subsurface wave propagation which, in turn, requires knowledge of subsurface velocity and attenuation properties. Tomographic approaches are the methods of choice for building velocity and attenuation (i.e., Q) models (see, e.g., Xin et al., 2014). Attenuation tomography input data can be obtained by analyzing pre-migration data in time (e.g., Quan and Harris, 1997) or by picking post-migration common-image-point gathers in depth. The advantages of picking post-migration data include known image points, focused primary energy with flat gathers, and opportunities of further denoising and data conditioning. For iterative tomographic velocity analysis widely practiced in the industry, picking with known image points has some advantages such as the potential to distinguish signal from noise. The main disadvantage of picking post migration is that wavelets in the image domain suffer from moveout stretch, dip stretch, velocity stretch, and distortions of amplitude and phase by the modeling and imaging algorithms. Such stretches and distortions compromise spectrum-based attenuation analysis. Picking on pre-migration data, on the other hand, avoids such issues. One drawback with picking pre-migration data is that premigration data can contain a superposition of multiple primary arrivals, residual multiples, diffractions, converted waves, and other noise. To benefit from the advantages of both premigration and post-migration analysis, Xin et al. (2014) propose weighting both premigration picking and post-migration picking as input to tomography. For premigration picking, they proposed a central frequency shift method. For post-migration picking, to mitigate the adverse impact of wavelet stretch, they propose to apply de-stretch by reverse NMO. Migration can also distort wavelet spectra that varies with source and receiver geometries in other ways than wavelet stretches. To help appreciate this point, an extreme example would be to see the change in wavelet shapes (thus different spectra) of a target line migration output as the migration input widens from a single-line input to a wide-swath input. By weighted combination of picks in both premigration and post-migration, the approach of Xin et al. partially realizes the advantages of both. We propose a new approach that analyzes attenuation (i.e., picking attenuated traveltimes t* or related attributes) and computes Q-factor using premigration data and then uses weighted migrations to map t* and Q model to the image domain. This completely avoids issues of picking in the imaging domain. Once mapped to the image domain, the attenuated traveltime t* can be used in a conventional tomographic approach to obtain a high-resolution Q model.

Seismic data is processed to create seismic images that can be interpreted to identify subsurface geologic features including hydrocarbon deposits. The ability to define the location of rock and fluid property changes in the subsurface is crucial to our ability to make the most appropriate choices for hydrocarbon identification, safe operation, and successful completion of projects. Project cost is dependent upon accurate prediction of the position of physical boundaries within the Earth. Decisions include, but are not limited to, planning budgets, obtaining mineral and lease rights, signing well commitments, permitting rig locations, designing well paths and drilling strategy, preventing subsurface integrity issues by planning proper casing and cementation strategies, and selecting and purchasing appropriate completion and production equipment.

There exists a need for improved understanding of attenuation in seismic energy to improve velocity modeling and seismic imaging needed for identifying and delineating hydrocarbon reservoirs. Correcting for phase errors caused by seismic wave dispersion due to attenuation will lead to more accurate imaging positioning of the subsurface rock boundaries, including reservoir depths. Because higher frequency seismic data are attenuated exponentially more severely than lower frequency seismic data, compensating seismic energy in amplitudes will lead to high resolution of seismic imaging and will result in more accurate seismic amplitude-versus-offset (AVO) analysis for quantitative seismic interpretation.

### SUMMARY

In accordance with some embodiments, a method of seismic data processing including receiving a seismic dataset D(s, r; t) representative of a subsurface volume of interest; calculating a pre-migration attenuated travel time t*(s, r; t); performing a first migration on D(s, r; t) to generate common image point (CIP) gathers G(x, h) wherein x is subsurface image point and h is angle or offset; performing a second migration on D(s, r; t)*t*(s, r; t) to generate weighted common image point (CIP) gathers G_{t*}(x, h); and calculating a conditioned ratio of the weighted CIP gathers G_{t*}(x, h) over the CIP gathers G(x, h) to get CIP gathers of attenuated traveltime t*(x, h) wherein the conditioning prevents division by zero is disclosed. The method may also display the CIP gathers of attenuated traveltime t*(x, h) on a graphical display. The CIP gathers of attenuated traveltime t*(x, h) may be used to perform seismic tomography to generate an attenuation (Q) model.

In another aspect of the present invention, to address the aforementioned problems, some embodiments provide a non-transitory computer readable storage medium storing one or more programs. The one or more programs comprise instructions, which when executed by a computer system with one or more processors and memory, cause the computer system to perform any of the methods provided herein.

In yet another aspect of the present invention, to address the aforementioned problems, some embodiments provide a computer system. The computer system includes one or more processors, memory, and one or more programs. The one or more programs are stored in memory and configured to be executed by the one or more processors. The one or more programs include an operating system and instructions that when executed by the one or more processors cause the computer system to perform any of the methods provided herein.

### BRIEF DESCRIPTION OF THE DRAWINGS

FIG. 1A illustrates incremental change of attenuated traveltime between two closely spaced points along a one-way transmission ray path;

FIG. 1B illustrates incremental change of attenuated traveltimes and ray paths for two closely spaced reflection events;

FIG. 2 illustrates a flowchart of a method of seismic attenuation compensation, in accordance with some embodiments;

FIG. 3 is a demonstration of a step of method of seismic attenuation compensation, in accordance with some embodiments;

FIG. 4 is a demonstration of a step and a result of method of seismic attenuation compensation, in accordance with some embodiments; and

FIG. 5 is a block diagram illustrating a seismic imaging system, in accordance with some embodiments.

Like reference numerals refer to corresponding parts throughout the drawings.

### DETAILED DESCRIPTION OF EMBODIMENTS

Described below are methods, systems, and computer readable storage media that provide a manner of compensating for attenuation in seismic data. These embodiments take full advantage of both pre-migration and post-migration picking while avoiding the problems described above with conventional methods.

Reference will now be made in detail to various embodiments, examples of which are illustrated in the accompanying drawings. In the following detailed description, numerous specific details are set forth in order to provide a thorough understanding of the present disclosure and the embodiments described herein. However, embodiments described herein may be practiced without these specific details. In other instances, well-known methods, procedures, components, and mechanical apparatus have not been described in detail so as not to unnecessarily obscure aspects of the embodiments.

Advantageously, those of ordinary skill in the art will appreciate, for example, that the embodiments provided herein may be utilized to generate a more accurate digital seismic image (i.e., the corrected digital seismic image). The more accurate digital seismic image may improve hydrocarbon exploration and improve hydrocarbon production. The more accurate digital seismic image may provide details of the subsurface that were illustrated poorly or not at all in traditional seismic images. Moreover, the more accurate digital seismic image may better delineate where different features begin, end, or any combination thereof. As one example, the more accurate digital seismic image may illustrate faults and/or salt flanks more accurately. As another example, assume that the more accurate digital seismic image indicates the presence of a hydrocarbon deposit. The more accurate digital seismic image may delineate more accurately the bounds of the hydrocarbon deposit so that the hydrocarbon deposit may be produced.

Those of ordinary skill in the art will appreciate, for example, that the more accurate digital seismic image may be utilized in hydrocarbon exploration and hydrocarbon production for decision making. For example, the more accurate digital seismic image may be utilized to pick a location for a wellbore. Those of ordinary skill in the art will appreciate that decisions about (a) where to drill one or more wellbores to produce the hydrocarbon deposit, (b) how many wellbores to drill to produce the hydrocarbon deposit, etc. may be made based on the more accurate digital seismic image. The more accurate digital seismic image may even be utilized to select the trajectory of each wellbore to be drilled. Moreover, if the delineation indicates a large hydrocarbon deposit, then a higher number of wellbore locations may be selected and that higher number of wellbores may be drilled, as compared to delineation indicating a smaller hydrocarbon deposit.

Those of ordinary skill in the art will appreciate, for example, that the more accurate digital seismic image may be utilized in hydrocarbon exploration and hydrocarbon production for control. For example, the more accurate digital seismic image may be utilized to steer a tool (e.g., drilling tool) to drill a wellbore. A drilling tool may be steered to drill one or more wellbores to produce the hydrocarbon deposit. Steering the tool may include drilling around or avoiding certain subsurface features (e.g., faults, salt diapirs, shale diapirs, shale ridges, pockmarks, buried channels, gas chimneys, shallow gas pockets, and slumps), drilling through certain subsurface features (e.g., hydrocarbon deposit), or any combination thereof depending on the desired outcome. As another example, the more accurate digital seismic image may be utilized for controlling flow of fluids injected into or received from the subsurface, the wellbore, or any combination thereof. As another example, the more accurate digital seismic image may be utilized for controlling flow of fluids injected into or received from at least one hydrocarbon producing zone of the subsurface. Chokes or well control devices, positioned on the surface or downhole, may be used to control the flow of fluid into and out. For example, certain subsurface features in the more accurate digital seismic image may prompt activation, deactivation, modification, or any combination thereof of the chokes or well control devices so as control the flow of fluid. Thus, the more accurate digital seismic image may be utilized to control injection rates, production rates, or any combination thereof.

Those of ordinary skill in the art will appreciate, for example, that the more accurate digital seismic image may be utilized to select completions, components, fluids, etc. for a wellbore. A variety of casing, tubing, packers, heaters, sand screens, gravel packs, items for fines migration, etc. may be selected for each wellbore to be drilled based on the more accurate digital seismic image. Furthermore, one or more recovery techniques to produce the hydrocarbon deposit may be selected based on the more accurate digital seismic image.

In short, those of ordinary skill in the art will appreciate that there are many decisions (e.g., in the context of (a) steering decisions, (b) landing decisions, (c) completion decisions, (d) engineering control systems and reservoir monitoring in the following but not limited to: Tow Streamer, Ocean Bottom Sensor, VSP, DAS VSP, and imaging with both primaries and free surface multiple, etc.) to make in the hydrocarbon industry and making proper decisions based on more accurate digital seismic images should improve the likelihood of safe and reliable operations. For simplicity, the many possibilities, including wellbore location, component selection for the wellbore, recovery technique selection, controlling flow of fluid, etc., may be collectively referred to as managing a subsurface reservoir.

The present invention includes embodiments of a method and system for compensating for attenuation (Q) in seismic energy. It has been shown that, within the seismic frequency band, frequency-independent Q factor is adequate to describe the frequency dependent attenuation. The formulation can be conveniently described in terms of a complex (i.e., with real and imaginary parts) velocity:

$$V ( x ) = {v}_{0} ( x ) \cdot [ 1 + \frac{i}{2 Q} + \frac{1}{π Q} \cdot ln ( \frac{ω}{{ω}_{0}} ) ]$$

where vector x=(x, y, z) represents an arbitrary subsurface spatial position, ω is the angular frequency, ω₀ is a reference angular frequency, v₀(x) is the real velocity at the reference frequency. For one-way wave propagation from a surface point s (e.g., a location of a source) to a subsurface point x (i.e., a vector position with x, y, z coordinates), the seismic amplitudes A(s, x; ω) at x can be represented by

A(s,x)=Aₛ·exp[iωT(s,x)],

where Aₛ=A(s, s) is the starting amplitude at s, and T(s, x) is the complex time

$$T ( s , x ) = t ( s , x ) - \frac{i}{2} \cdot {t}^{*} ( s , x ) - \frac{1}{π} \cdot {t}^{*} ( s , x ) \cdot ln ( \frac{ω}{{ω}_{0}} ) .$$

In the above equation, t(s, x) is real traveltime along the ray path from s to x,

$$t ( s , x ) = {\int }_{ray ( s \to x )} \frac{d σ}{{v}_{0}} ,$$

and t*(s, x) is the “attenuated traveltime”,

$${t}^{*} ( s , x ) = {\int }_{ray ( s \to x )} \frac{d σ}{{v}_{0} \cdot Q} .$$

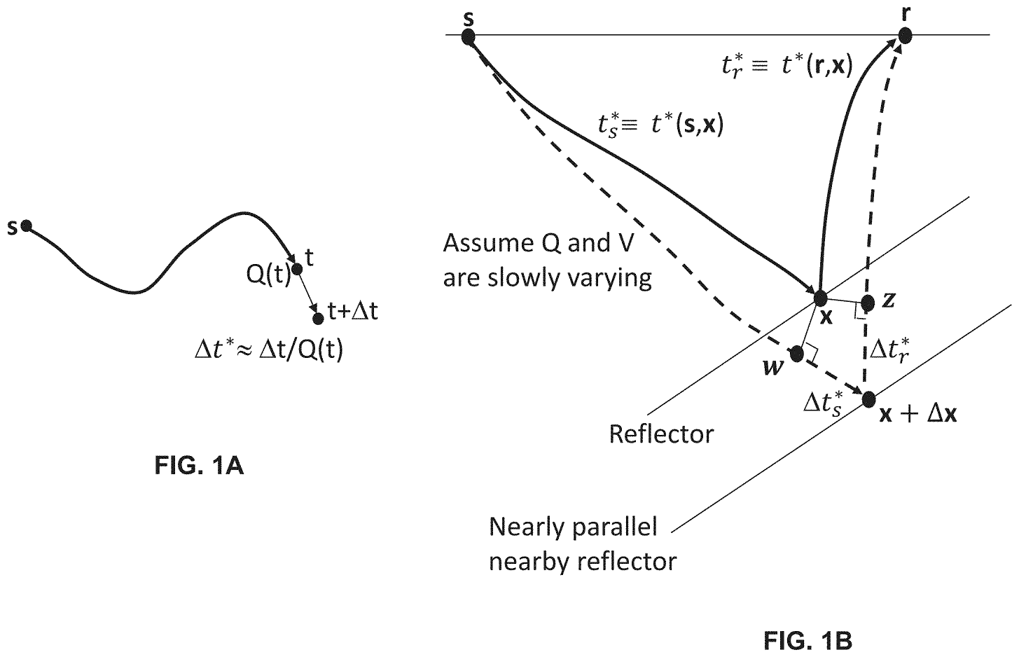

The integrations are with respect to a ray path length parameter σ. The position x and the medium properties (i.e., Q and v) in the integrands can be viewed as functions of path length σ. If we use the travel time t instead of the path length σ to parameterize the ray path with dt=dσ/v, then t*(s,x) can be expressed as

$${t}^{*} ( s , x ) = {\int }_{ray ( s \to x )} \frac{dt}{Q} ,$$

where x and Q are considered functions of traveltime parameter t along the ray path. FIG. 1A illustrates this concept in differencing form: if we know the attenuation time at two adjacent points x(t) and x(t+Δt) separated by a traveltime Δt and attenuation time Δt* along a one-way ray, we have

Δt*≈Δt/Q(t),

where Q(t) is understood to be Q(x(t)) as an implicit function of t along the ray path x(t).

For reflection data, the ray path has two legs: the source leg from the source point s to a subsurface reflection point x and the receiver leg from x to the receiver point r. Two events separated by a small travel time difference Δt for the given s and r will correspond to two specular reflection points x and x+Δx separated by small displacement Δx. FIG. 1B illustrates the situation. The total traveltime is

$$t ( s , r ; x ) = t ( s , x ) + t ( x , r ) = {\int }_{ray ( s \to x )} \frac{d σ}{{v}_{0}} + {\int }_{ray ( x \to r )} \frac{d σ}{{v}_{0}} ,$$

and the total attenuated traveltime is

$${t}^{*} ( s , r ; x ) = {t}^{*} ( s , x ) + {t}^{*} ( x , r ) = {\int }_{ray ( s \to x )} \frac{d σ}{{v}_{0} \cdot Q} + {\int }_{ray ( x \to r )} \frac{d σ}{{v}_{0} \cdot Q} .$$

Conventional raytracing-based tomography uses the above equation to invert for 1/Q given attenuation input t*(s, r; x) converted from imaging domain picks t*(x, h), where h is a variable for trace axis (e.g., offset or angle) in common-image-point gathers G(x, h). What has been plaguing existing approaches is to pick the needed post-migration t*(x, h) using post-migration gathers G(x, h) which suffers wavelet stretch and spectral distortions. We propose picking attenuated time t*(s, r; t) in the time domain using premigration data D(s, r; t) and the time domain picks t*(s, r; t) to t*(x, h) by multiple migrations and stationary-phase divisions. The effect of attenuative wave propagation on the data of D(s, r; t) varies with time and can be measured by partitioning the data into overlapping time windows. For a time window centered at time t_{win}, the spectrum is assumed be of the form

$$G ( s , r ; {t}_{win} ) = A ( s , r ; {t}_{win} ) \cdot 𝒮 ( ω ) \cdot exp [ - \frac{ω {t}^{*} ( s , r ; {t}_{win} )}{2} + \frac{i \cdot {t}^{*} ( s , r ; {t}_{win} )}{π} \cdot ω \cdot ln ( \frac{ω}{{ω}_{0}} ) ]$$

where [symbol] (ω) is the source spectrum, A(s, r; t_{win}) accounts for geometric spreading and other factors less sensitive to frequency than attenuation is. References abound in the literature on obtaining t* by linear fit of the log-spectral ratio

$$ln ( \vert \frac{G ( s , r ; {t}_{win} )}{G ( s , r ; {t}_{ref} )} \vert ) = ln ( \vert \frac{A ( s , r ; {t}_{win} )}{A ( s , r ; {t}_{ref} )} \vert ) - \frac{ω}{2} \cdot {t}^{*} ( s , r ; {t}_{win} ) ,$$

where the t_{ref} corresponds to the time window before the spectrum is affected by attenuation with t*(s, r; t_{ref})=0. This provides the zero-attenuation reference spectrum for taking the spectral ratio. For marine data, the time at the water bottom reflection is a good candidate for the t_{ref}. The source spectrum can also be used for the reference spectrum. The above equation shows that attenuated time t* at t_{win} can be found from slope in the best-fit line to the log-spectrum versus frequency plot. See Xin et al (2014) for a recent example of this approach. Quan and Harris (1997) proposed a frequency shift approach for estimating the attenuated time.

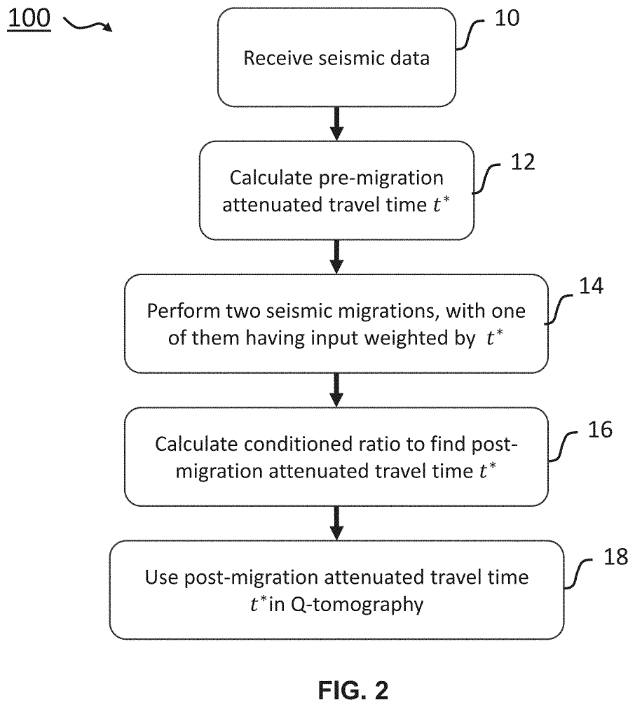

FIG. 2 illustrates a flowchart of a method 100 for seismic imaging of a complex subsurface volume of interest. At operation 10, a seismic dataset, premigration data D(s, r; t), is received. As previously described, the seismic dataset includes a plurality of traces recorded at a plurality of seismic sensors. This dataset may have already been subjected to a number of seismic processing steps, such as deghosting, multiple removal, spectral shaping, and the like. These examples are not meant to be limiting. Those of skill in the art will appreciate that there are a number of useful seismic processing steps that may be applied to seismic data before it is deemed ready for imaging.

Operation 12 calculates the attenuated travel time t*(s, r; t) where s is the source location and r is the receiver location. Since pre-migration data is in the time domain, the calculation will not suffer from frequency distortion due to normal moveout or migration stretch. Neither will it suffer from other potential amplitude-and-spectrum-distorting effects of the migration processes. The current invention also does not limit how t*(s, r; t) is picked in the premigration data D(s, r; t). In particular, because t*(s, r; t) is a sample-by-sample match in time to each individual trace position (s, r), it does not require any specific sort of the premigration data. In an embodiment, this operation may include a time-varying high-cut filter to avoid high frequency noise in the data while picking. A general recommendation for trace-wise windowed frequency spectra R(s, r; f; t_{win}) is as follows:
For either land or marine data, t*(s, r; t) can be computed from the windowed spectral ratio of R(s, r; f; t_{win}) with the source spectrum S(s, r; f), and t_{win} is the time at the center of the window.
For marine data, t*(s, r; t) can be conveniently computed from the spectral ratio of windowed spectrum R(s, r; f; t_{win}) with R(s, r; f; t_{wb}), where t_{wb}(s, r) is the arrival time of the water bottom reflection.

Quan and Harris (1997) using centroid frequency shift and Xin et al. (2014) using central frequency shift are but two examples of picking t*(s, r; t). Wang and Gao (2018) suggest using peak frequencies instead of centroid frequencies. Carter and Kendall (2006) propose using dominant frequencies.

Operation 14 performs two migrations, one with input data D(s, r; t) to get the common-image point (CIP) image gather G(x, h), and another migration with t*-weighted input data D(s, r; t)·t*(s, r; t) to get the weighted CIP image gather G_{t*}(x, h). Here the variable h indicates the gather trace axis. It can be a scalar-like absolute value of source-receiver offset or reflection angle. It can also be a vector-like source-receiver offset vector or azimuth-reflector angle pair. Let M(x, h; s, r) be the migration kernel that yields the CIP gather G(x, h) given input D(s, r; t):

G(x,h)=ΣₛΣᵣM(x,h;s,r)·D(s,r;t),

and

G_{t*}(x,h)=ΣₛΣᵣM(x,h;s,r)·D(s,r;t)·t*(s,r;t).

The above approach of using weighted migrations to obtain specular reflection ray attributes has been applied in other contexts. Bleistein (1987) suggested weighted differential stack migration for obtain ray incident angles. Tygel et al. (1993) and Chen (2004) suggested using weights in differential stack migration to obtain reflection dip, specular sources and receivers at each subsurface image point x. Here we use the approach to map information about the subsurface (i.e., attenuation) that can be better analyzed in the time domain but are needed in the image domain.

Operations 14 and 16 are for mapping the premigration time-domain pick t*(s, r; t) to the post-migration depth-domain t*(x, h), which is suitable for input to tomography in operation 18. Even though each of the two migrations in operation 14 will still stretch the wavelet and may still distort the amplitude spectrum in other ways, according to the stationary-phase principle, the spatially slow-varying attenuated travel time t*(x, h) can still be obtained as a conditioned ratio of the two migrations. The spectra of the two migrations are distorted in an identical manner and thus the distortions will not impact the calculation of their ratio.

Since the attenuated time t*(x, h) is derived from the results of migrations, the benefits of the migrations can be realized. The benefits include known image points, focused primary energy with flat gathers, and opportunities of further denoising and data conditioning. One such opportunity is post-migration Radon denoising to further clean up residual multiples. The computational cost of the two migrations should not be major concern. They can be carried cheaply with low-frequency migrations and they are not significant in the context of iterative imaging processes requiring multiple rounds of migrations and tomographic model updates.

Operation 16 takes a conditioned ratio these weighted migration G_{t*}(x, h) over the unweighted migration G(x, h) to get the attenuated travel time t*(x, h):

$${t}^{*} ( x , h ) = \frac{{\sum }_{win} {G}_{{t}^{*}} ( x , h ) \cdot G ( x , h )}{{\sum }_{win} {[ G ( x , h ) ]}^{2}} ,$$

where the summation Σ_{win}( . . . ) is over a small spatial window around x. For image regions with non-vertical reflector dip, the summation can be over 1-D z-window with the width Δz on the order of a wavelength. The conditioning is to avoid division by 0 that would occur in a simple division of G_{t*}/G and to get the ratio t*(x, h) that varies spatially smoothly and slowly in comparison with dominant wavelength of the wavelet which is rapidly varying.

Operation 18 uses the post-migration attenuated travel time t*(x, h) for Q-tomography. Q-tomography is a well-established art in the industry. The scope of the invention does not include using premigration picks t*(s, r; t) directly as in some tomographic strategies (e.g., Lambare, 2008, Xin et al. 2014). We aim our invention towards providing simple and geophysically correct attenuation picking for the industry's widely adopted tomographic approach based on ray-tracing with known image points x and source-receiver vector offset h or angle. For velocity tomography, the spectra of the post-migration data are not a major concern for picking residual moveout. On the other hand, for Q tomography, the spectra of the data are of critical importance. However, to our knowledge, practitioners of Q-tomography using reflection data still pick attenuated travel times t*(x, h) based the post-migrated data spectra. This motivates our current invention. Even though our invention still relies on migrations, it does not rely on the compromised spectra of migrated data. This is the key point. It uses the spectra of premigration data to pick the attenuated travel time t*(s, r; t), and uses the migrations only to help locate the specular image positions (x, h) given recorded signal position (s, r; t).

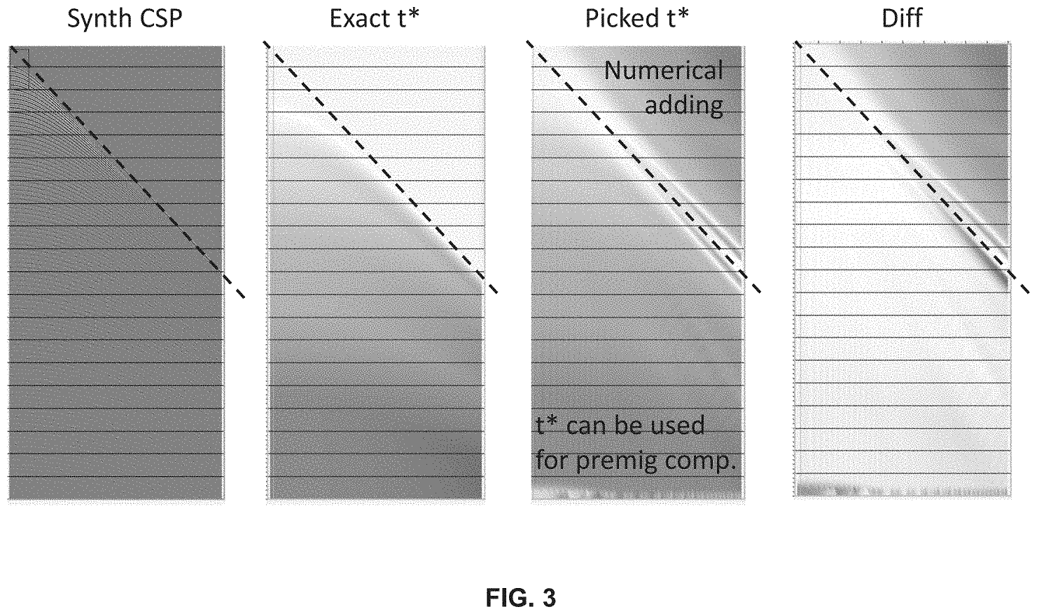

FIG. 3 shows synthetic data D(s, r; t) (first panel from left), exact attenuated time t*(s, r; t) (second panel) predicted using the exact 1/Q model, picked attenuated time t*(s, r; t) (third panel) using the premigration data D(s, r; t), and the difference between the picked and exact t*. The small difference in the last panel validates the picking procedure.

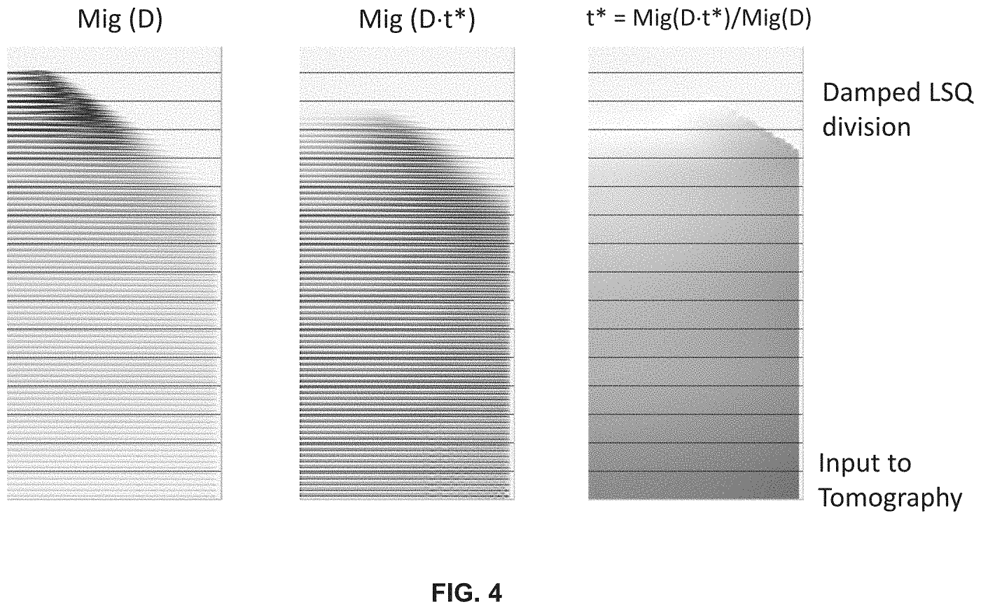

FIG. 4 shows CIP gather G(x, h)=Mig(D) (first panel from the left) using migration of the synthetic data D(s, r; t), CIP gather G_{t*}(x, h)=Mig(D·t*) (second panel) using migration of the synthetic data D(s, r; t) weighted by attenuated time t*(s, r; t), and attenuated time CIP gather t*(x, h) converted to the image domain by conditioned stationary-phase division of the two migrations G_{t*}(x, h) and G(x, h).

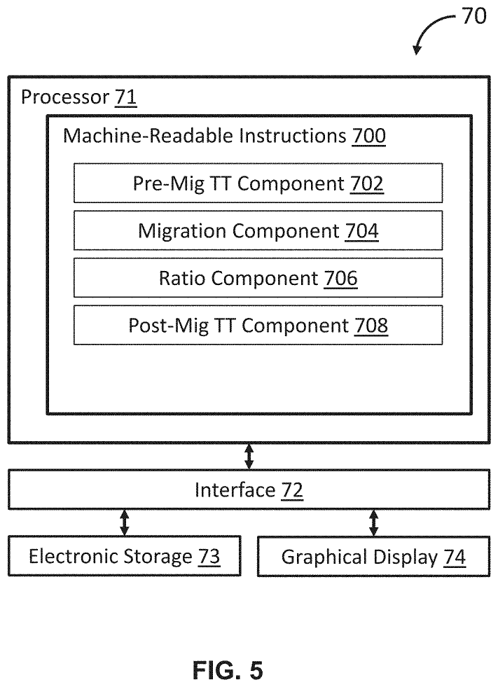

FIG. 5 is a block diagram illustrating a seismic attenuation system 70, in accordance with some embodiments. While certain specific features are illustrated, those skilled in the art will appreciate from the present disclosure that various other features have not been illustrated for the sake of brevity and so as not to obscure more pertinent aspects of the embodiments disclosed herein.

To that end, the seismic attenuation system 70 includes one or more processors 71, one or more interfaces 72, non-transitory electronic storage 73, and a graphical display 74. Electronic storage 73 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Electronic storage 73 comprises a non-transitory computer readable storage medium and may store seismic data, velocity models, seismic images, and/or geologic structure information.

In some embodiments, electronic storage 73 stores the following programs, modules and data structures, or a subset thereof including an operating system, a network communication module, and machine-readable instructions 700.

The operating system includes procedures for handling various basic system services and for performing hardware dependent tasks. The network communication module facilitates communication with other devices via communication network interfaces (wired or wireless) and one or more communication networks, such as the Internet, other wide area networks, local area networks, metropolitan area networks, and so on.

In some embodiments, the machine-readable instructions 700 include a pre-migration travel time component 702 which is a set of instructions to execute operation 12 of method 100. The machine-readable instructions 700 also may include a migration component 704 which is a set of instructions to execute both migrations of operation 14 and a ratio component 706 which is a set of instructions to execute operation 16. Although specific operations have been identified for the components discussed herein, this is not meant to be limiting. Each component may be configured to execute operations identified as being a part of other components, and may contain other instructions, metadata, and parameters that allow it to execute other operations of use in processing data and generating images. For example, any of the components may optionally be able to generate a display that would be sent to and shown on the graphical display 74. In addition, any of the data or processed data products may be transmitted via the communication interface or the network interface and may be stored in electronic storage 73.

Method 100 is, optionally, governed by instructions that are stored in computer memory or a non-transitory computer readable storage medium (e.g., electronic storage 73 in FIG. 5) and are executed by one or more processors (e.g., processor 71) of one or more computer systems. The computer readable storage medium may include a magnetic or optical disk storage device, solid state storage devices such as flash memory, or other non-volatile memory device or devices. The computer readable instructions stored on the computer readable storage medium may include one or more of: source code, assembly language code, object code, or another instruction format that is interpreted by one or more processors. In various embodiments, some operations in each method may be combined and/or the order of some operations may be changed from the order shown in the figures. For ease of explanation, method 100 is described as being performed by a computer system, although in some embodiments, various operations of method 100 are distributed across separate computer systems.

While particular embodiments are described above, it will be understood it is not intended to limit the invention to these particular embodiments. On the contrary, the invention includes alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the embodiments.

The terminology used in the description of the invention herein is for the purpose of describing particular embodiments only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, operations, elements, and/or components, but do not preclude the presence or addition of one or more other features, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

Although some of the various drawings illustrate a number of logical stages in a particular order, stages that are not order dependent may be reordered and other stages may be combined or broken out. While some reordering or other groupings are specifically mentioned, others will be obvious to those of ordinary skill in the art and so do not present an exhaustive list of alternatives. Moreover, it should be recognized that the stages could be implemented in hardware, firmware, software or any combination thereof.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

### REFERENCES

Bleistein, N., On the imaging of reflectors in the earth, GEOPHYSICS, VOL. 52, NO. 7 (July 1987); P. 931-942
Carter, A. J., and Kendall, J. M., 2006, Attenuation anisotropy and the relative frequency content of split shear waves, Geophys. J. Int. (2006) 165, 865-874
Chen, J., 2004, Specular ray parameter extraction and stationary-phase migration, GEOPHYSICS, VOL. 69, NO. 1 (January-February 2004); P. 249-256
Lambare, L., 2008, Stereotomography, GEOPHYSICS, VOL. 73, NO. 5 September-October 2008; P. VE25-VE34
Quan, Y, and Harris, J. M., 1997, Seismic attenuation tomography using the frequency shift method, GEOPHYSICS, VOL. 62, NO. 3 (May-June 1997); P. 895-905
Tygel, M., Schleicher, J., Hubral, P., and Hanitzsch, C., 1993, Multiple weights in diffraction stack migration, GEOPHYSICS, VOL. 59, NO. 12 (December 1993); P. 1820-1830
Wang, Q., and Gao, J., 2018, An improved peak frequency shift method for Q estimation based on generalized seismic wavelet function, J. Geophys. Eng. 15 (2018) pp. 164-178
Xin, K., He, Y., Xie, Y., Xu, W., Wang, M., 2014, Robust Q tomographic inversion through adaptive extraction of spectral features, 2014 SEG Annual Meeting Expanded Abstract

What is claimed is:

1. A computer-implemented method of seismic data processing, comprising:
a. receiving, at a computer processor, a seismic dataset D(s, r; t) representative of a subsurface volume of interest;
b. calculating a pre-migration attenuated travel time t*(s, r; t);
c. performing a first migration on D(s, r; t) to generate common image point (CIP) gathers G(x, h) wherein x is subsurface image point and h is angle or offset;
d. performing a second migration on D(s, r; t)*t*(s, r; t) to generate weighted common image point (CIP) gathers G_{t*}(x, h); and
e. calculating a conditioned ratio of the weighted CIP gathers G_{t*}(x, h) over the CIP gathers G(x, h) to get CIP gathers of attenuated traveltime t*(x, h) wherein the conditioning prevents division by zero.

2. The method of claim 1 further comprising using the CIP gathers of attenuated traveltime t*(x, h) to perform seismic tomography to generate an attenuation (Q) model.

3. The method of claim 1 further comprising displaying the CIP gathers of attenuated traveltime t*(x, h) on a graphical display.

4. The method of claim 2 further comprising displaying the Q model on a graphical display.

5. The method of claim 2 further comprising using the Q model for seismic imaging of the seismic dataset to generate a seismic image.

6. The method of claim 5 further comprising displaying the seismic image on a graphical display.

7. A computer system, comprising:
one or more processors;
memory; and
one or more programs, wherein the one or more programs are stored in the memory and configured to be executed by the one or more processors, the one or more programs including instructions that when executed by the one or more processors cause the system to:
a. receive, at the one or more processors, a seismic dataset D(s, r; t) representative of a subsurface volume of interest;
b. calculate pre-migration attenuated travel time t(s, r; t);
c. perform a first migration on D(s, r; t) to generate common image point (CIP) gathers G(x, h) wherein x is subsurface image point and h is angle or offset;
d. perform a second migration on D(s, r; t)*t*(s, r; t) to generate weighted common image point (CIP) gathers G_{t*}(x, h); and
e. calculate a conditioned ratio of the weighted CIP gathers G_{t*}(x, h) over the CIP gathers G(x, h) to get CIP gathers of attenuated traveltime t*(x, h) wherein the conditioning prevents division by zero.

8. The computer system of claim 7 further comprising using the CIP gathers of attenuated traveltime t*(x, h) to perform seismic tomography to generate an attenuation (Q) model.

9. The computer system of claim 7 further comprising displaying the CIP gathers of attenuated traveltime t*(x, h) on a graphical display.

10. A non-transitory computer readable storage medium storing one or more programs, the one or more programs comprising instructions, which when executed by an electronic device with one or more processors and memory, cause the device to:
a. receive, at the one or more processors, a seismic dataset D(s, r; t) representative of a subsurface volume of interest;
b. calculate pre-migration attenuated travel time t(s, r; t);
c. perform a first migration on D(s, r; t) to generate common image point (CIP) gathers G(x, h) wherein x is subsurface image point and h is angle or offset;
d. perform a second migration on D(s, r; t)*t*(s, r; t) to generate weighted common image point (CIP) gathers G_{t*}(x, h); and
e. calculate a conditioned ratio of the weighted CIP gathers G_{t*}(x, h) over the CIP gathers G(x, h) to get CIP gathers of attenuated traveltime t*(x, h) wherein the conditioning prevents division by zero.
